(19) United States
(12) Patent Application Publication
(10) Pub. No.: US 2019/0052333 A1
(43) Pub. Date: Feb. 14, 2019

(54) Method for Feeding Back Hybrid Channel State Information, Terminal Device, and Base Station

(71) Applicant: Huawei Technologies Co., Ltd., Shenzhen (CN)

(72) Inventors: Kai Xu, Shenzhen (CN); Yanliang Sun, Beijing (CN); Bin Liu, San Diego, CA (US); Richard Stirling-Gallacher, Munich (DE)

(73) Assignee: Huawei Technologies Co., Ltd., Shenzhen (CN)

(21) Appl. No.: 16/078,386

(22) PCT Filed: Mar. 24, 2017
(86) PCT No.: PCT/CN2017/078019

§ 371 Date: Aug. 21, 2018

(30) Foreign Application Priority Data
Sep. 29, 2016 (CN) 201610865613.0

(51) Int. Cl. H04B 7/06; H04L 5/00

(52) U.S. Cl. CPC H04B 7/0626; H04B 7/0617; H04L 5/0048

(57) ABSTRACT

A method for feeding back hybrid channel state information (CSI), a terminal device, and a base station, where the method includes reporting, by a terminal device, CSI to a base station, where the CSI is reported in two stages, CSI used when a quantity of beamformed CSI reference signal (CSI-RS) resources is greater than one is reported in a first stage, and CSI used when the quantity of the beamformed CSI-RS resources is equal to one is reported in a second stage, and reporting the CSI in the two stages occupies one CSI reporting process. In this method, hybrid CSI is reported based on a beamformed CSI-RS. Therefore, CSI reporting overheads can be reduced, and CSI reporting accuracy can be improved such that a cell throughput can be increased.

This application claims priority to Chinese Patent Application No. 201610865613.0, filed with the Patent Office of the State Intellectual Property Office of China on Sep. 29, 2016, and entitled “METHOD AND DEVICE FOR FEEDING BACK HYBRID CHANNEL STATE INFORMATION”, which is incorporated herein by reference in its entirety.

### TECHNICAL FIELD

The present invention relates to the field of communications technologies, and in particular, to a method for feeding back hybrid channel state information, a terminal device, and a base station.

### BACKGROUND

In a conventional 4th generation communications technology (4th Generation, 4G) mobile communications system or a Long Term Evolution (Long Term Evolution, LTE) system, a main objective of downlink channel measurement is to obtain channel state information (Channel State Information, CSI), so that downlink scheduling and downlink data transmission are more convenient. If a spatial multiplexing or beamforming (Beamforming, BF) multiple-input multiple-output (Multiple Input Multiple Output, MIMO) transmission mode is used in a downlink, a terminal device needs to feed back CSI information to a side of a base station. The CSI includes a channel quality indicator (Channel Quality Indicator, CQI), a precoding matrix indicator (Precoding Matrix Indicator, PMI), a rank indicator (Rank Indicator, RI), and the like. CSI feedback supports periodic and aperiodic trigger manners. Usually, a period of the RI is longer than a period of the PMI and a period of the CQI.

A double codebook structure is introduced in Release 10 of a 3rd Generation Partnership Project (3rd Generation Partnership Project, 3GPP) communications system. In the double codebook structure, the PMI needs to be reported in two stages, and a precoding matrix generated based on the PMI reported in the two stages may be denoted as W=W₁W₂. W₁ is a channel matrix generated by reporting a PMI in a first stage, reflects a wideband statistics feature of a channel within a relatively long time, and can be indicated as one beam cluster. W₂ is a channel matrix generated by reporting a PMI in a second stage, reflects a narrowband feature of a channel within a relatively short time, and is used to select a beam from the one beam cluster of W₁, and select phase parameters in different antenna polarization directions.

A beamformed CSI-RS is introduced in 3GPP Release 13, to enhance coverage performance of the CSI-RS while a non-beamformed CSI-RS is still reserved. In a case other than carrier aggregation, a terminal device supports a maximum of one CSI process, and does not support, in each CSI process, simultaneously sending CSI information based on the beamformed CSI-RS and CSI information based on the non-beamformed CSI-RS. When the CSI is reported based on the beamformed CSI-RS, in addition to an RI, a PMI, or a CQI, channel state information reference signal resource index (CSI-RS Resource Index, CRI) information needs to be further reported. A reporting period of the CRI is not shorter than a reporting period of the RI.

Usually, a hybrid CSI reporting mechanism based on the beamformed CSI-RS and the non-beamformed CSI-RS has been agreed. The CSI information based on the non-beamformed CSI-RS is reported in a first stage, only an indication of W₁ in the PMI information and/or the RI are/is reported, and an indication of W₂ in the PMI information and the CQI are not reported. The CSI information based on the beamformed CSI-RS when a quantity of CSI-RS resources is 1 is reported in a second stage, and the CSI information includes the RI, the PMI, and the CQI.

However, the existing hybrid CSI reporting mechanism does not provide a method for feeding back hybrid CSI based on different beamformed CSI-RS resources. Information overheads required for reporting the existing hybrid CSI are relatively high, and a configuration is not flexible enough. Consequently, inaccuracy of the reported information may be caused.

### SUMMARY

Embodiments of the present invention relate to a method for feeding back hybrid channel state information, a terminal device, and a base station, to resolve a prior-art problem that a method for feeding back hybrid CSI based on different beamformed CSI-RS resources is not provided, information reporting overheads are high, and a configuration is inflexible.

According to a first aspect, an embodiment of the present invention provides a method for feeding back hybrid channel state information. The method includes: reporting, by a terminal device, channel state information CSI to a base station, where the CSI is reported in two stages, CSI used when a quantity of beamformed channel state information reference signal CSI-RS resources is greater than 1 is reported in a first stage, CSI used when the quantity of beamformed CSI-RS resources is equal to 1 is reported in a second stage, and reporting the CSI in the two stages occupies one CSI reporting process.

Specifically, hybrid CSI is reported based on a beamformed CSI-RS. Therefore, information overheads of reporting the CSI are reduced, a flexible configuration can be implemented, and CSI reporting accuracy is improved, to increase a cell throughput. In addition, average spectral efficiency of a cell user and spectral efficiency of a cell-edge user are increased, and interference between neighboring cells is reduced.

In a possible embodiment, the CSI includes at least one of a channel state information reference signal resource index CRI, a rank indicator RI, a precoding matrix indicator PMI, and a channel quality indicator CQI. The CSI is reported in the two stages by using a same codebook, and the codebook is used to indicate a format of the CSI. That CSI used when a quantity of beamformed CSI-RS resources is greater than 1 is reported in a first stage includes: a CRI and the RI and/or the PMI that correspond to n CSI-RS resources used when the quantity of beamformed CSI-RS resources is greater than 1 are reported in the first stage, where n is an integer greater than 1. That CSI used when the quantity of beamformed CSI-RS resources is equal to 1 is reported in a second stage includes: a CRI, a CQI, and an RI and/or a PMI that correspond to one of n CSI-RS resources used when the quantity of beamformed CSI-RS resources is equal to 1 are reported in the second stage.

In a possible embodiment, the CSI includes at least one of a CRI, an RI, a PMI, and a CQI. The CSI is reported in the two stages by using different codebooks, and the codebooks are used to indicate formats of the CSI. That CSI used when a quantity of beamformed CSI-RS resources is greater than 1 is reported in a first stage includes: a CRI, a PMI and an RI that correspond to n CSI-RS resources used when the quantity of beamformed CSI-RS resources is greater than 1 are reported in the first stage, where n is an integer greater than 1. That CSI used when the quantity of beamformed CSI-RS resources is equal to 1 is reported in a second stage includes: a CRI, a CQI, a PMI, and an RI that correspond to one of n CSI-RS resources used when the quantity of beamformed CSI-RS resources is equal to 1 are reported in the second stage.

Specifically, a configuration type of the beamformed CSI-RS includes two cases: The quantity of CSI-RS resources is greater than 1 and the quantity of CSI resources is equal to 1. When the quantity of CSI-RS resources is greater than 1, each CSI-RS resource may correspond to one transmit antenna port. When the quantity of CSI resources is equal to 1, each CSI-RS resource usually corresponds to a plurality of transmit antenna ports.

In a possible embodiment, the PMI reported in the first stage is used to indicate a group of beams, and the PMI reported in the second stage is used to select a beam and a phase from the group of beams.

Specifically, when a PMI matrix is reported in a CSI in two stages, a PMI reported in a CSI in a first stage indicates a group of beams, and a PMI reported in a CSI in a second stage is used to select a beam and a phase from the group of beams. The PMI reported in the first stage can indicate a wide beam, and the PMI reported in the second stage is based on the PMI reported in the first stage. Therefore, a PMI searching range can be narrowed to obtain a more accurate beam.

In a possible embodiment, a dimension of a codebook used to report the CSI in the first stage is less than a dimension of a codebook used to report the CSI in the second stage.

In a possible embodiment, the method further includes: determining, by the terminal device, CSI configuration information. The CSI configuration information includes at least one of a subframe offset parameter, a codebook parameter, and a CSI reporting indication. The subframe offset parameter is used to indicate a CSI reporting subframe interval corresponding to different CSI-RS resources used when the CSI is reported in the first stage and an interval between subframes in which the CSI is reported in the two stages. The codebook parameter is used to indicate a format of the CSI reported in the first stage and a format of the CSI reported in the second stage. The CSI reporting indication is used to indicate that the CSI is reported in the first stage, that the CSI is reported in the second stage, or that the CSI is simultaneously reported in the two stages.

In a possible embodiment, the determining, by the terminal device, CSI configuration information includes: determining, by the terminal device, the CSI configuration information based on information configured or preconfigured by the base station.

According to a second aspect, an embodiment of the present invention provides another method for feeding back hybrid channel state information. The method includes: receiving, by a base station, channel state information CSI reported by a terminal device in two stages; and determining, by the base station based on CSI configuration information, the CSI reported by the terminal device. The CSI configuration information includes at least one of a subframe offset parameter, a codebook parameter, and a CSI reporting indication. The subframe offset parameter is used to indicate a CSI reporting subframe interval corresponding to different CSI-RS resources used when CSI is reported in a first stage and an interval between subframes in which the CSI is reported in the two stages. The codebook parameter is used to indicate a format of the CSI reported in the first stage and a format of CSI reported in a second stage. The CSI reporting indication is used to indicate that the CSI is reported in the first stage, that the CSI is reported in the second stage, or that the CSI is simultaneously reported in the two stages.

In a possible embodiment, the method further includes: determining, by the base station, the CSI configuration information based on information configured or preconfigured by the terminal device.

According to a third aspect, an embodiment of the present invention provides a terminal device. The terminal device includes: a transmitter, configured to report channel state information CSI to a base station. The CSI is reported in two stages, CSI used when a quantity of beamformed channel state information reference signal CSI-RS resources is greater than 1 is reported in a first stage, CSI used when the quantity of beamformed CSI-RS resources is equal to 1 is reported in a second stage, and reporting the CSI in the two stages occupies one CSI reporting process.

In a possible embodiment, the CSI includes at least one of a channel state information reference signal resource index CRI, a rank indicator RI, a precoding matrix indicator PMI, and a channel quality indicator CQI. The CSI is reported in the two stages by using a same codebook, and the codebook is used to indicate a format of the CSI. The transmitter is specifically configured to: report, in the first stage, a CRI and an RI and/or a PMI that correspond to n CSI-RS resources used when the quantity of beamformed CSI-RS resources is greater than 1, where n is an integer greater than 1; and report, in the second stage, a CRI, a CQI, and an RI and/or a PMI that correspond to one of n CSI-RS resources used when the quantity of beamformed CSI-RS resources is equal to 1.

In a possible embodiment, the CSI includes at least one of a CRI, an RI, a PMI, and a CQI. The CSI is reported in the two stages by using different codebooks, and the codebooks are used to indicate formats of the CSI. The transmitter is specifically configured to: report, in the first stage, a CRI, a PMI and an RI that correspond to n CSI-RS resources used when the quantity of beamformed CSI-RS resources is greater than 1, where n is an integer greater than 1; and report, in the second stage, a CRI, a CQI, a PMI, and an RI that correspond to one of n CSI-RS resources used when the quantity of beamformed CSI-RS resources is equal to 1.

In a possible embodiment, the PMI reported in the first stage is used to indicate a group of beams, and the PMI reported in the second stage is used to select a beam and a phase from the group of beams.

In a possible embodiment, a dimension of a codebook used to report the CSI in the first stage is less than a dimension of a codebook used to report the CSI in the second stage.

In a possible embodiment, the terminal device further includes: a processor, configured to determine CSI configuration information. The CSI configuration information includes at least one of a subframe offset parameter, a codebook parameter, and a CSI reporting indication. The subframe offset parameter is used to indicate a CSI reporting subframe interval corresponding to different CSI-RS resources used when the CSI is reported in the first stage and an interval between subframes in which the CSI is reported in the two stages. The codebook parameter is used to indicate a format of the CSI reported in the first stage and a format of the CSI reported in the second stage. The CSI reporting indication is used to indicate that the CSI is reported in the first stage, that the CSI is reported in the second stage, or that the CSI is simultaneously reported in the two stages.

In a possible embodiment, the terminal device further includes: a receiver and a memory. The processor is specifically configured to determine the CSI configuration information based on information that is configured by the base station and that is received by the receiver. Alternatively, the processor is specifically configured to determine the CSI configuration information based on preconfigured information stored in the memory.

According to a fourth aspect, an embodiment of the present invention provides a base station. The base station includes: a receiver, configured to receive channel state information CSI reported by a terminal device in two stages; and a processor, configured to determine, based on CSI configuration information, the CSI reported by the terminal device. The CSI configuration information includes at least one of a subframe offset parameter, a codebook parameter, and a CSI reporting indication. The subframe offset parameter is used to indicate a CSI reporting subframe interval corresponding to different CSI-RS resources used when CSI is reported in a first stage and an interval between subframes in which the CSI is reported in the two stages. The codebook parameter is used to indicate a format of the CSI reported in the first stage and a format of CSI reported in a second stage. The CSI reporting indication is used to indicate that the CSI is reported in the first stage, that the CSI is reported in the second stage, or that the CSI is simultaneously reported in the two stages.

In a possible embodiment, the base station further includes a memory. The processor is specifically configured to determine the CSI configuration information based on information that is configured by the terminal device and that is received by the receiver. Alternatively, the processor is specifically configured to determine the CSI configuration information based on preconfigured information stored in the memory.

Based on the foregoing technical solutions, by using the method for feeding back hybrid channel state information, the terminal device, and the base station that are provided in the embodiments of the present invention, the method for feeding back hybrid CSI can be implemented, so that average spectral efficiency of a cell user and spectral efficiency of a cell-edge user are increased, and interference between neighboring cells is reduced.

### BRIEF DESCRIPTION OF DRAWINGS

FIG. 1 is a schematic architectural diagram of a communications system according to an embodiment of the present invention;

FIG. 2 is a schematic diagram of a beam corresponding to a PMI according to an embodiment of the present invention.

FIG. 3 is a schematic diagram of reporting first hybrid CSI according to an embodiment of the present invention;

FIG. 4 is a schematic diagram of reporting second hybrid CSI according to an embodiment of the present invention;

FIG. 5 is a schematic diagram of reporting third hybrid CSI according to an embodiment of the present invention;

FIG. 6 is a schematic diagram of reporting fourth hybrid CSI according to an embodiment of the present invention;

FIG. 7 is a schematic diagram of reporting fifth hybrid CSI according to an embodiment of the present invention;

FIG. 8 is a schematic structural diagram of a terminal device according to an embodiment of the present invention;

FIG. 9 is a schematic structural diagram of another terminal device according to an embodiment of the present invention;

FIG. 10 is a schematic structural diagram of a base station according to an embodiment of the present invention; and

FIG. 11 is a schematic structural diagram of another base station according to an embodiment of the present invention.

### DESCRIPTION OF EMBODIMENTS

The following describes the technical solutions in the embodiments of the present invention with reference to the accompanying drawings in the embodiments of the present invention.

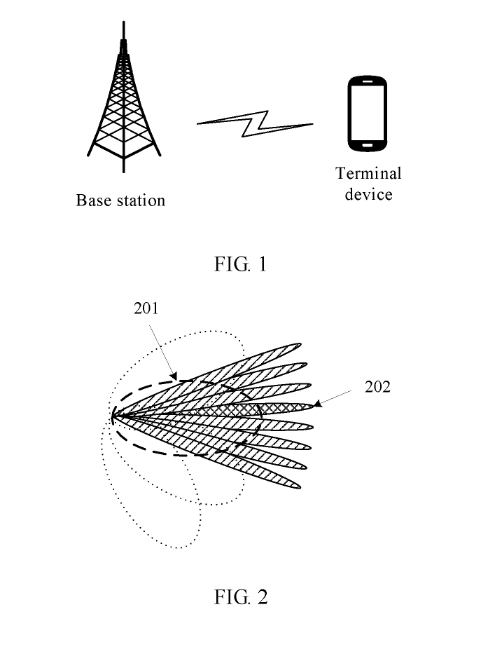

FIG. 1 is a schematic architectural diagram of a communications system according to an embodiment of the present invention. As shown in FIG. 1, the communications system includes: a terminal device and a base station. The terminal device and the base station communicate with each other through a physical channel. The terminal device performs downlink channel measurement, and feeds back CSI information to the base station. The base station schedules a downlink and sends downlink data based on the CSI information.

A technology described in this embodiment of the present invention may be applicable to an LTE system or a 4G system, or another multiple-antenna communications system using various radio access technologies. In addition, the technology may be further applicable to a subsequent evolved system of the LTE system, such as a Long Term Evolution Advanced (LTE-Advanced, LTE-A) system or a 5th generation communications technology (5 Generation, 5G) mobile communications system. For clarity, the 4G system is used as an example herein for description.

In a further mobile communications system, a multiple-antenna technology is widely used on a side of the base station and on a side of the terminal device. To further improve coverage performance and capacity performance of the mobile communications system, a downlink CSI-RS is sent by using a beamforming technology. A configuration type of a beamformed CSI-RS includes two cases: A quantity of CSI-RS resources is greater than 1 and the quantity of CSI resources is equal to 1. When the quantity of CSI-RS resources is greater than 1, each CSI-RS resource may correspond to one transmit antenna port. When the quantity of CSI resources is equal to 1, each CSI-RS resource usually corresponds to a plurality of transmit antenna ports. Different types of beamformed CSI-RSs report different CSI contents, and when the quantity of CSI-RS resources is greater than 1, a CRI needs to be reported. Because only one type of CSI-RS may be configured in one CSI process in a conventional mobile communications system, problems of CSI reporting inaccuracy and high overheads are caused. To further improve CSI reporting accuracy, and reduce CSI reporting overheads, hybridizing different types of CSI into one CSI process for reporting attracts public attention. For example, different from a time division duplex (Time Division Duplex, TDD) system, a frequency division duplex (Frequency Division Duplex, FDD) system cannot use channel reciprocity. Therefore, reporting hybrid CSI based on the beamformed CSI-RS appears to be particularly important.

In a further multiple-antenna mobile communications system, hybrid CSI is reported in two stages based on the beamformed CSI-RS. CSI used when a quantity of CSI-RS resources is greater than 1 is reported in a first stage, CSI used when a quantity of CSI-RS resources is equal to 1 is reported in a second stage, and the two different types of CSI are reported in one CSI process. There are several possible embodiment solutions below depending on whether codebooks used to report the CSI in the two stages are the same.

In a possible embodiment, the hybrid CSI is reported in the two stages based on the beamformed CSI-RS by using a same codebook. The CSI used when the quantity of beamformed CSI-RS resources is greater than 1 is reported in the first stage, and includes a CRI, an RI, and/or a PMI that correspond to n CSI-RS resources, and n is an integer greater than 1. The CSI reported in the second stage is based on the CSI reported in the first stage. The reported CSI used when the quantity of beamformed CSI-RS resources is equal to 1 includes a CRI, a PMI, a CQI, and/or an RI that correspond to one of n CSI-RS resources. Specifically, when the CSI is reported based on the beamformed CSI-RS, in addition to at least one of the RI, the PMI, and the CQI, CRI information needs to be reported both when the CSI is reported in the first stage and when the CSI is reported in the second stage.

The CRI reported in the CSI in the first stage indicates a CSI-RS sending resource corresponding to the CSI reported in the second stage. When a channel changes relatively slowly, because there is a relatively high probability that the RI reported in the CSI in the second stage is the same as the RI reported in the CSI in the first stage, the RI may not be reported in the CSI in the second stage. When the CSI is reported in the two stages by using the same codebook, a PMI matrix may be reported in the CSI in the first stage or may be reported in the CSI in the second stage. Alternatively, the PMI matrix may be separately reported in the CSI in the two stages. When the PMI matrix is reported in the CSI in the two stages, the PMI reported in the CSI in the first stage indicates a group of beams, and the PMI reported in the CSI in the second stage is used to select a beam and a phase from the group of beams. Specifically, reporting the CSI in the first stage may be configured to be triggered periodically, and reporting the CSI in the second stage may be configured to be triggered aperiodically, so that CSI reporting overheads can be reduced.

In another possible embodiment, the hybrid CSI is reported in the two stages based on the beamformed CSI-RS by using different codebooks. The CSI used when the quantity of beamformed CSI-RS resources is greater than 1 is reported in the first stage, and includes a CRI, an RI, and a PMI that correspond to n CSI-RS resources, and n is an integer greater than 1. The CSI reported in the second stage is based on the CSI reported in the first stage, and the reported CSI used when the quantity of beamformed CSI-RS resources is equal to 1 includes a CRI, an RI, a PMI and a CQI that correspond to one of n CSI-RS resources. The PMI reported in the CSI in the first stage may indicate a value range of the PMI reported in the CSI in the second stage. The CSI may be reported in the first stage by using a codebook having a relatively small dimension, and the CSI may be reported in the second stage by using a codebook having a relatively large dimension. A dimension of a codebook herein reflects a quantity of antennas performing beamforming, which is indicated by the codebook. Specifically, the PMI reported in the first stage can indicate a wide beam, and the PMI reported in the second stage is based on the PMI reported in the first stage. Therefore, a PMI searching range can be narrowed to obtain a more accurate beam.

The communications system provided in this embodiment of the present invention reports the hybrid CSI based on the beamformed CSI-RS. Therefore, information overheads of reporting the CSI are reduced, a flexible configuration can be implemented, and CSI reporting accuracy is improved, to increase a cell throughput. In addition, average spectral efficiency of a cell user and spectral efficiency of a cell-edge user are increased, and interference between neighboring cells is reduced.

In a possible embodiment, the terminal device reports channel state information CSI to the base station. The CSI is reported in two stages, CSI used when a quantity of beamformed channel state information reference signal CSI-RS resources is greater than 1 is reported in a first stage, CSI used when the quantity of beamformed CSI-RS resources is equal to 1 is reported in a second stage, and reporting the CSI in the two stages occupies one CSI reporting process.

In a possible embodiment, the CSI is reported in the two stages by using a same codebook, and the codebook is used to indicate a format of the CSI. That CSI used when a quantity of beamformed CSI-RS resources is greater than 1 is reported in a first stage includes: a CRI and an RI and/or a PMI that correspond to n CSI-RS resources used when the quantity of beamformed CSI-RS resources is greater than 1 are reported in the first stage. That CSI used when the quantity of beamformed CSI-RS resources is equal to 1 is reported in a second stage includes: a CRI, a CQI, and an RI and/or a PMI that correspond to one of n CSI-RS resources used when the quantity of beamformed CSI-RS resources is equal to 1 are reported in the second stage.

In a possible embodiment, some parameters can be configured to support periodic reporting of the hybrid CSI, and specifically include: an offset of a subframe in which the CSI is reported in the first stage. The CSI configuration information indicates a CSI reporting subframe interval corresponding to different CSI-RS resources used when the CSI is periodically reported in the first stage. The parameters further include an offset of an interval between a subframe in which the CSI reported in the first stage and a subframe in which the CSI reported in the second stage. The CSI configuration information indicates an interval between a subframe in which the CSI is periodically reported in the first stage and a subframe in which the CSI is periodically reported in the second stage. In addition, a CSI reporting indication can be further configured, to indicate that the CSI is reported in the first stage or that the CSI is reported in the second stage. In addition, the following CSI configuration information may be further added: a codebook type indication. The CSI configuration information indicates a type of a codebook for reporting the CSI in the first stage and a type of a codebook for reporting the CSI in the second stage.

In a possible embodiment, the CSI configuration information can be sent by a network side or a side of the base station to a side of the terminal device, so that the side of the terminal device can use the CSI configuration information. Usually, periodically reported CSI configuration information is sent by using higher layer radio resource control (Radio Resource Control, RRC) signaling, and aperiodically reported CSI configuration information is sent by using a physical layer downlink control indicator (Downlink Control Indicator, DCI). Alternatively, the CSI configuration information may be automatically configured on the side of the terminal device, and related CSI configuration information is then sent to the side of the base station.

In a possible embodiment, the CRI reported in the CSI in the first stage indicates a CSI-RS sending resource corresponding to the CSI reported in the second stage. When a channel changes relatively slowly, because there is a relatively high probability that the RI reported in the CSI in the second stage is the same as the RI reported in the CSI in the first stage, the RI may not be reported in the CSI in the second stage.

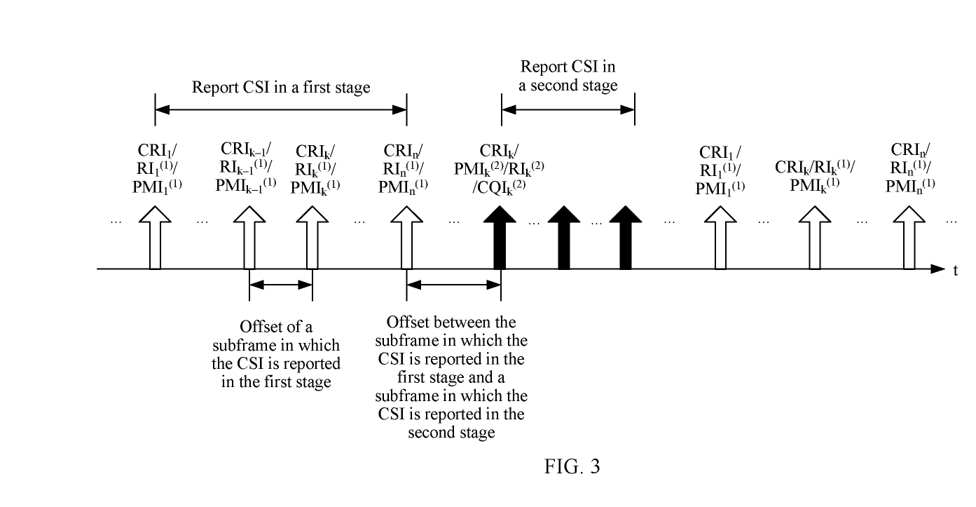

In a possible embodiment, the PMI reported in the CSI in the first stage indicates a group of beams, and the PMI reported in the CSI in the second stage is used to select a beam and a phase. FIG. 2 is a schematic diagram of a beam corresponding to a PMI according to an embodiment of the present invention. As shown in FIG. 2, 201 represents the group of beams indicated by the PMI reported in the CSI in the first stage, and 202 represents the beam and the phase that are selected, by the PMI reported in the CSI in the second stage, in the group of beams shown in 201. Alternatively, in this embodiment of the present invention, the PMI information may be not reported in the CSI in the first stage, and the PMI information is reported in the CSI in the second stage. Alternatively, the PMI information is reported in the CSI in the first stage, and the PMI information is not reported in the CSI in the second stage.

In the method for reporting hybrid CSI provided in this embodiment of the present invention, a configuration is more efficient, reporting the CSI in the first stage may be configured to be triggered periodically, and reporting the CSI in the second stage may be configured to be triggered aperiodically, so that CSI reporting overheads can be reduced.

Correspondingly, FIG. 3 is a schematic diagram of reporting first hybrid CSI according to an embodiment of the present invention. As shown in FIG. 3, in a possible example, a terminal device periodically reports CSI to a base station in two stages. A CRI, an RI, and a PMI that correspond to n CSI-RS resources used when a quantity of beamformed CSI-RS resources is greater than 1 are reported in CSI in a first stage. For reporting CSI in a second stage, one piece of preferable CSI is selected from the CSI that corresponds to the n CSI-RS resources and that is reported in the CSI in the first stage. Assuming that a k^{th} CSI-RS resource corresponds to a piece of optimum CSI, a CRI, an RI, a PMI, and a CQI that correspond to the k^{th} CSI-RS resource are reported in the CSI in the second stage, where k is an integer greater than or equal to 1. The PMI reported in the first stage is used to indicate sending a group of beams, and the PMI reported in the second stage is used to select a beam and a phase.

In a possible example, the PMI reported in the CSI in the second stage is based on the PMI reported in the CSI in the first stage, and the PMI reported in the CSI in the first stage indicates a value range of the PMI reported in the CSI in the second stage. The CSI may be reported in the first stage by using a Release-12 codebook or a Release-13 codebook having a relatively small dimension, and the CSI may be reported in the second stage by using a Release-14 codebook having a relatively large dimension.

In a possible example, this embodiment further includes: determining, by the terminal device, CSI configuration information. The CSI configuration information includes at least one of a subframe offset parameter, a codebook parameter, and a CSI reporting indication.

Specifically, the subframe offset parameter is used to indicate a CSI reporting subframe interval corresponding to different CSI-RS resources used when the CSI is reported in the first stage and an interval between subframes in which the CSI is reported in the two stages. The subframe offset parameter includes a subframe interval offset of reporting the CSI in the first stage, and an offset of an interval between a subframe in which the CSI reported in the first stage and a subframe in which the CSI reported in the second stage. The CSI reporting subframe interval corresponding to different CSI-RS resources is determined based on the subframe interval offset of reporting the CSI in the first stage. The interval between the subframe in which the CSI reported in the first stage and the subframe in which the CSI reported in the second stage is determined based on the offset of the interval between the subframe in which the CSI reported in the first stage and the subframe in which the CSI reported in the second stage.

Specifically, the codebook parameter is used to indicate a format of the CSI reported in the first stage and a format of the CSI reported in the second stage.

Specifically, the CSI reporting indication is used to indicate that the CSI in the first stage is reported or that the CSI in the second stage is reported. In a possible implementation, the terminal device may determine, based on the CSI reporting indication, to report the CSI in the first stage or to report the CSI in the second stage. Likewise, the base station may also determine, by determining corresponding CSI configuration information, that a received subframe is a subframe in which the terminal device reports the CSI in the first stage or a subframe in which the terminal device reports the CSI in the second stage.

In a possible example, the CSI configuration information is configured or preconfigured by the base station.

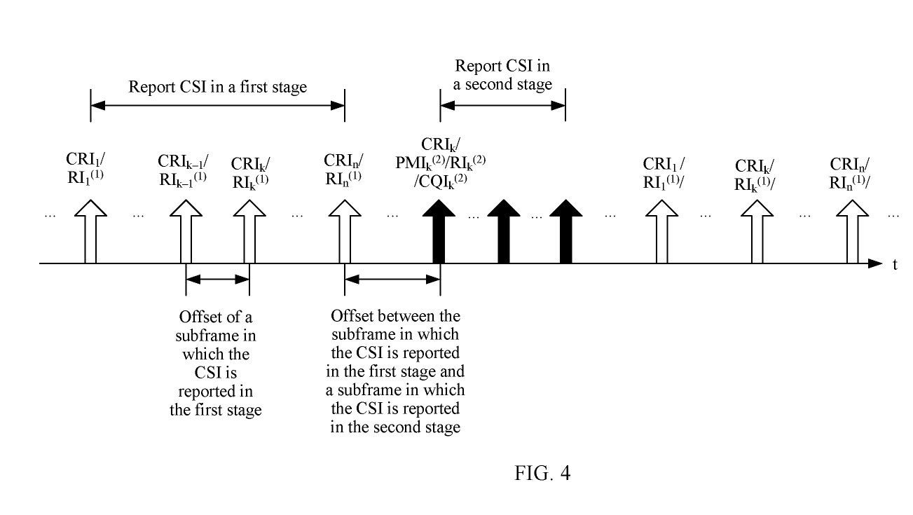

Correspondingly, FIG. 4 is a schematic diagram of reporting second hybrid CSI according to an embodiment of the present invention. As shown in FIG. 4, in a possible example, a terminal device periodically reports CSI to a base station in two stages. A CRI and an RI that correspond to n CSI-RS resources used when a quantity of beamformed CSI-RS resources is greater than 1 are reported in CSI in a first stage. For reporting CSI in a second stage, one piece of preferable CSI is selected from the CSI that corresponds to the n CSI-RS resources and that is reported in the CSI in the first stage. Assuming that a k^{th} CSI-RS resource corresponds to a piece of optimum CSI, a CRI, an RI, a PMI, and a CQI that correspond to the k^{th} CSI-RS resource are reported in the CSI in the second stage. In the embodiment shown in FIG. 3, the PMI is not reported in the CSI in the first stage, and the PMI is not reported in the CSI in the second stage.

In a possible example, for determining information such as a subframe offset, a codebook, or a CSI reporting indication in FIG. 3, refer to the descriptions in FIG. 2. Details are not described herein again.

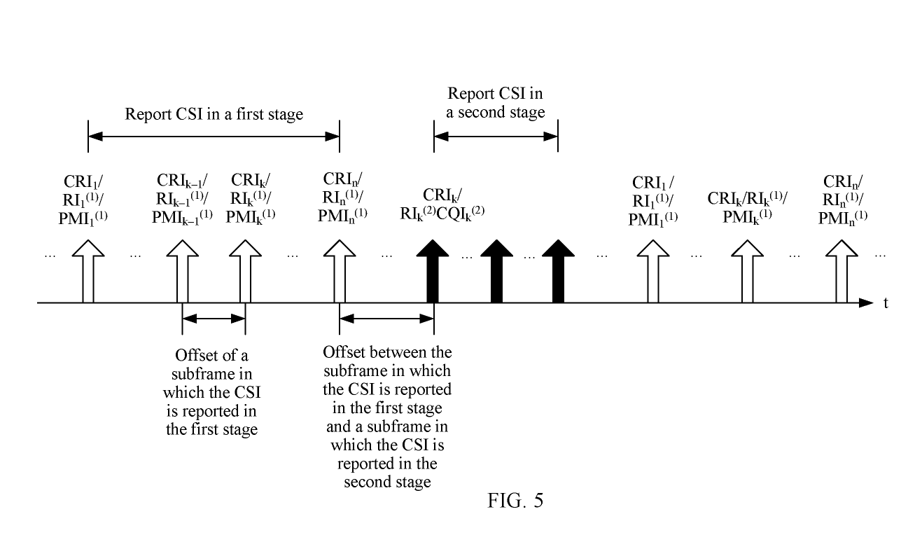

Correspondingly, FIG. 5 is a schematic diagram of reporting third hybrid CSI according to an embodiment of the present invention. As shown in FIG. 5, in a possible example, a terminal device periodically reports CSI to a base station in two stages. A CRI, an RI, and a PMI that correspond to CSI-RS resources used when a quantity of beamformed CSI-RS resources is greater than 1 are reported in CSI in a first stage. For reporting CSI in a second stage, one piece of preferable CSI is selected from the CSI that corresponds to the n CSI-RS resources and that is reported in the CSI in the first stage. Assuming that a k^{th} CSI-RS resource corresponds to a piece of optimum CSI, a CRI, an RI, and a CQI that correspond to the k^{th} CSI-RS resource are reported in the CSI in the second stage. In the embodiment shown in FIG. 4, the PMI is reported in the CSI in the first stage, and the PMI is not reported in the CSI in the second stage.

In a possible example, for determining of parameters, such as a subframe offset, a codebook, or a CSI reporting indication that are in FIG. 4, refer to the descriptions in FIG. 2. Details are not described herein again.

In a possible embodiment, in the embodiments shown in FIG. 3 to FIG. 5, when the CSI is reported in the two stages by using a same codebook, when a channel changes relatively slowly, the RI may not be reported in the CSI in the second stage. For brevity, details are not described.

In the embodiments shown in FIG. 3 to FIG. 5 in this application, the CSI is reported in the second stage based on a result of reporting the CSI in the first stage, different codebooks may be used, and a searching range of the PMI reported in the CSI in the second stage is narrowed. Therefore, CSI reporting accuracy is improved, and CSI reporting overheads can be effectively reduced. Two types of different CSI information are reported in one CSI process in this embodiment of the present invention. Therefore, CSI reporting overheads are reduced.

In a possible embodiment, the CSI is reported in the two stages by using different codebooks. That CSI used when a quantity of beamformed CSI-RS resources is greater than 1 is reported in a first stage includes: a CRI, a PMI, and an RI that are used when the quantity of beamformed CSI-RS resources are greater than 1 are reported in the first stage. That CSI used when the quantity of beamformed CSI-RS resources is equal to 1 is reported in a second stage includes: a CRI, a CQI, a PMI, and an RI that are used when the quantity of beamformed CSI-RS resources is equal to 1 are reported in the second stage.

In a possible embodiment, the CSI reporting indication may further indicate that reporting is simultaneously performed in the first stage and in the second stage, or reporting is performed only in the first stage, or reporting is performed only in the second stage.

In a possible embodiment, CSI configuration information may be further added: an offset between a subframe in which the CSI is aperiodically reported in the first stage and a subframe in which the CSI is aperiodically reported in the second stage. The CSI configuration information indicates an interval between the subframe in which the CSI is aperiodically reported in the first stage and the subframe in which the CSI is aperiodically reported in the second stage.

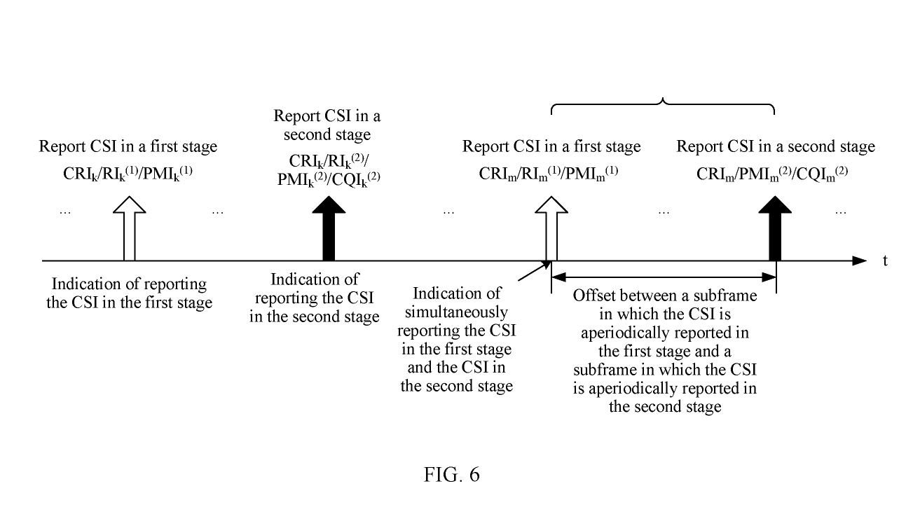

Correspondingly, FIG. 6 is a schematic diagram of reporting fourth hybrid CSI according to an embodiment of the present invention. As shown in FIG. 6, in a possible example, a terminal device aperiodically reports CSI to a base station in two stages. Aperiodically reporting hybrid CSI supports reporting CSI in a first stage, or reporting CSI in a second stage, or simultaneously reporting CSI in a first stage and CSI in a second stage. A specific reporting manner needs to be determined by using an indication of reporting the CSI in the first stage and/or an indication of reporting the CSI in the second stage. An interval between a subframe in which the CSI is aperiodically reported in the first stage and a subframe in which the CSI is aperiodically reported in the second stage is determined based on an offset between the subframe in which the CSI is aperiodically reported in the first stage and the subframe in which the CSI is aperiodically reported in the second stage. When the CSI is simultaneously reported in the first stage and in the second stage, an interval between a subframe in which the CSI is reported in the first stage and a subframe in which the CSI is reported in the second stage is indicated by an offset between a subframe in which the CSI is aperiodically reported in the first stage and a subframe in which the CSI is aperiodically reported in the second stage.

Specifically, when the hybrid CSI is aperiodically reported, the CSI reporting indication is used to indicate that the CSI is reported in the first stage, that the CSI is reported in the second stage, or that the CSI is simultaneously reported in the two stages. In a possible implementation, a period for reporting the CSI in the first stage is relatively long, and the CSI is reported in the second stage in a relatively short period or in an aperiodic trigger manner. Therefore, the terminal device may determine, based on the CSI reporting indication, that the CSI is reported in the first stage, that the CSI is reported in the second stage, or that the CSI is simultaneously reported in the two stages. Likewise, the base station may also determine, by determining corresponding CSI configuration information, that a received subframe is a subframe in which the terminal device reports the CSI in the first stage, a subframe in which the terminal device reports the CSI in the second stage, or a subframe in which the terminal device simultaneously reports the CSI in the two stages.

In this embodiment of the present invention, adding the CSI configuration information may support simultaneously reporting CSI in the first stage and in the second stage. Therefore, overheads of aperiodically reporting the CSI can be reduced. The CSI is reported in the first stage and in the second stage simultaneously and aperiodically, and overheads of aperiodically reporting the CSI can be reduced.

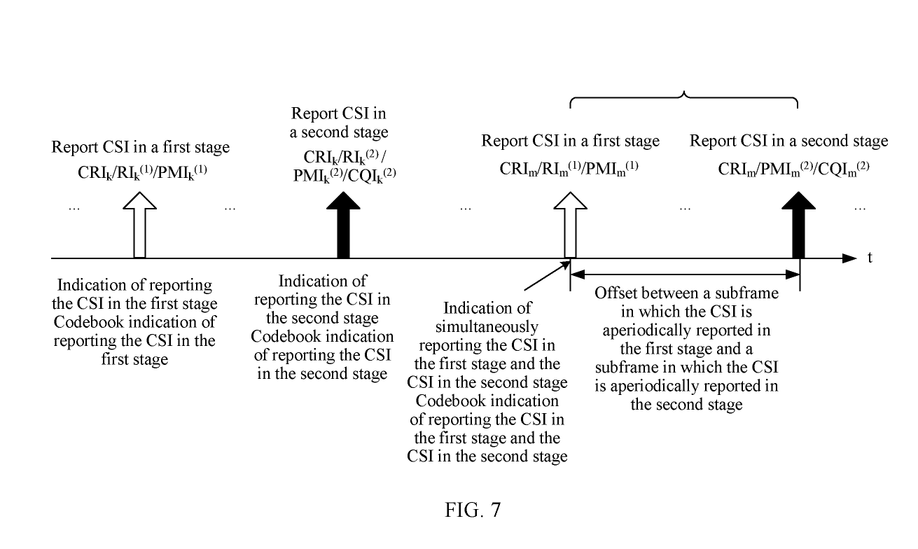

Correspondingly, FIG. 7 is a schematic diagram of reporting fifth hybrid CSI according to an embodiment of the present invention. As shown in FIG. 7, in a possible example, a terminal device aperiodically reports CSI to a base station in two stages. Aperiodically reporting hybrid CSI supports reporting CSI in a first stage, or reporting CSI in a second stage, or simultaneously reporting CSI in a first stage and CSI in a second stage. A specific reporting manner needs to be determined by using an indication of reporting the CSI in the first stage and/or an indication of reporting the CSI in the second stage. A specific codebook used for reporting needs to be determined by using a codebook indication. When the CSI is simultaneously reported in the first stage and in the second stage, an interval between a subframe in which the CSI is reported in the first stage and a subframe in which the CSI is reported in the second stage is indicated by an offset between a subframe in which the CSI is aperiodically reported in the first stage and a subframe in which the CSI is aperiodically reported in the second stage.

Specifically, when reporting the CSI, the terminal device may add CSI configuration information, such as CSI reporting indication information, codebook indication information, or subframe offset information, to the reported CSI information, so that the base station may accurately receive, based on the CSI configuration information carried in the CSI information, the CSI reported by the terminal device in the two stages.

In this embodiment of the present invention, adding the CSI configuration information may support simultaneously reporting the CSI in the first stage and in the second stage by using different codebooks. The CSI is reported in the second stage based on a result of reporting the CSI in the first stage. Therefore, a searching range of a PMI reported in the CSI in the second stage can be narrowed, and CSI reporting accuracy is improved. In this embodiment of the present invention, the CSI is reported in the first stage and in the second stage aperiodically and simultaneously by using different codebooks, and the searching range of the PMI reported in the CSI in the second stage is narrowed. Therefore, CSI reporting accuracy is improved.

In a possible embodiment, the base station receives the channel state information CSI reported by the terminal device in the two stages. The base station determines, based on the CSI configuration information, the CSI reported by the terminal device. The CSI configuration information includes at least one of a subframe offset parameter, a codebook parameter, and a CSI reporting indication. The subframe offset parameter is used to indicate a CSI reporting subframe interval corresponding to different CSI-RS resources used when CSI is reported in a first stage and an interval between subframes in which the CSI is reported in the two stages. The codebook parameter is used to indicate a format of the CSI reported in the first stage and a format of CSI reported in a second stage. The CSI reporting indication is used to indicate that the CSI is reported in the first stage, that the CSI is reported in the second stage, or that the CSI is simultaneously reported in the two stages.

In a possible embodiment, the base station determines the CSI configuration information based on information configured or preconfigured by the terminal device.

With reference to the embodiments shown in FIG. 1 to FIG. 7, in the method for feeding back hybrid CSI provided in the embodiments of the present invention, hybrid CSI is reported based on a beamformed CSI-RS. Therefore, average spectral efficiency of a cell user and spectral efficiency of a cell-edge user are increased, and interference between neighboring cells is reduced. In the method for feeding back hybrid CSI provided in this embodiment of the present invention, CSI reporting overheads can be reduced, and CSI reporting accuracy is improved, so that a cell throughput can be increased.

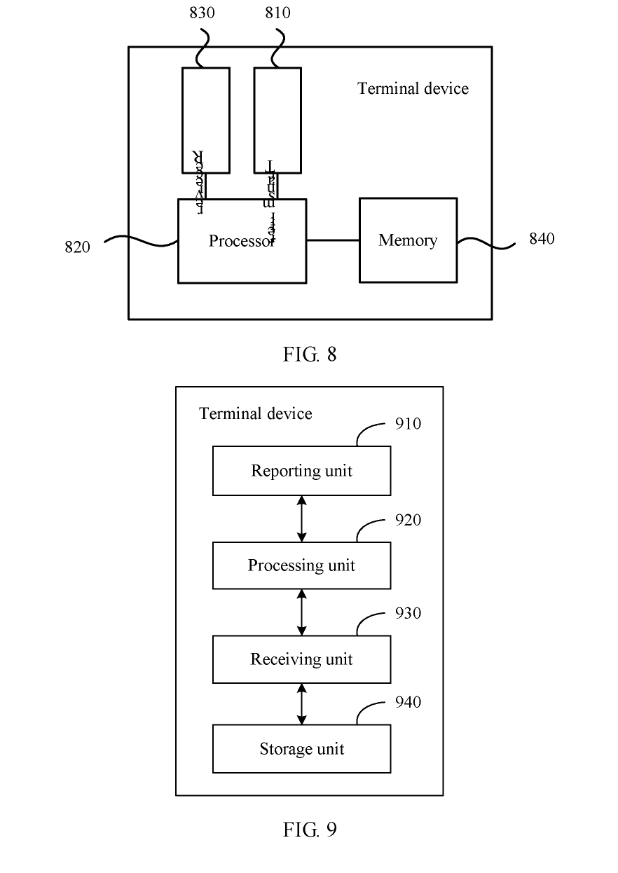

Correspondingly, an embodiment of the present invention provides a terminal device, to implement the method for feeding back hybrid CSI provided in the foregoing embodiments. As shown in FIG. 8, the terminal device includes: a transmitter 810, a processor 820, a receiver 830, and a memory 840.

The transmitter 810 of the terminal device provided in this embodiment is configured to report channel state information CSI to a base station. The CSI is reported in two stages, CSI used when a quantity of beamformed channel state information reference signal CSI-RS resources is greater than 1 is reported in a first stage, CSI used when the quantity of beamformed CSI-RS resources is equal to 1 is reported in a second stage, and reporting the CSI in the two stages occupies one CSI reporting process.

In a possible embodiment, the CSI includes at least one of a channel state information reference signal resource index CRI, a rank indicator RI, a precoding matrix indicator PMI, and a channel quality indicator CQI. The CSI is reported in the two stages by using a same codebook, and the codebook is used to indicate a format of the CSI. The transmitter 810 is specifically configured to: report, in the first stage, a CRI and an RI and/or a PMI that correspond to n CSI-RS resources used when the quantity of beamformed CSI-RS resources is greater than 1; and report, in the second stage, a CRI, a CQI, and an RI and/or a PMI that correspond to one of n CSI-RS resources used when the quantity of beamformed CSI-RS resources is equal to 1.

In a possible embodiment, the CSI includes at least one of a CRI, an RI, a PMI, and a CQI. The CSI is reported in the two stages by using different codebooks, and the codebooks are used to indicate formats of the CSI. The transmitter 810 is specifically configured to: report, in the first stage, a CRI, a PMI and an RI that correspond to n CSI-RS resources used when the quantity of beamformed CSI-RS resources is greater than 1; and report, in the second stage, a CRI, a CQI, a PMI, and an RI that correspond to one of n CSI-RS resources used when the quantity of beamformed CSI-RS resources is equal to 1.

In a possible embodiment, the PMI reported in the first stage is used to indicate a group of beams, and the PMI reported in the second stage is used to select a beam and a phase from the group of beams.

In a possible embodiment, a dimension of a codebook used to report the CSI in the first stage is less than a dimension of a codebook used to report the CSI in the second stage.

In a possible embodiment, the processor 820 is configured to determine CSI configuration information. The CSI configuration information includes at least one of a subframe offset parameter, a codebook parameter, and a CSI reporting indication. The subframe offset parameter is used to indicate a CSI reporting subframe interval corresponding to different CSI-RS resources used when the CSI is reported in the first stage and an interval between subframes in which the CSI is reported in the two stages. The codebook parameter is used to indicate a format of the CSI reported in the first stage and a format of the CSI reported in the second stage. The CSI reporting indication is used to indicate that the CSI is reported in the first stage, that the CSI is reported in the second stage, or that the CSI is simultaneously reported in the two stages.

In a possible embodiment, the processor 820 is specifically configured to determine the CSI configuration information based on information that is configured by the base station and that is received by the receiver 830. Alternatively, the processor 820 is specifically configured to determine the CSI configuration information based on preconfigured information stored in the memory 840.

In addition, the terminal device provided in this embodiment of the present invention may further use the following implementation, to implement the method for feeding back hybrid CSI in the foregoing embodiments of the present invention. As shown in FIG. 9, the terminal device includes: a reporting unit 910, a processing unit 920, a receiving unit 930, and a storage unit 940.

In an optional embodiment, the transmitter 810 in the embodiment in FIG.

8 may be replaced with the reporting unit 910. The processor 820 may be replaced with the processing unit 920. The receiver 830 may be replaced with the receiving unit 930. The memory 840 may be replaced with the storage unit 940.

For a processing procedure of each unit in FIG. 9, refer to the specific embodiments shown in FIG. 1 to FIG. 8. Details are not described herein again.

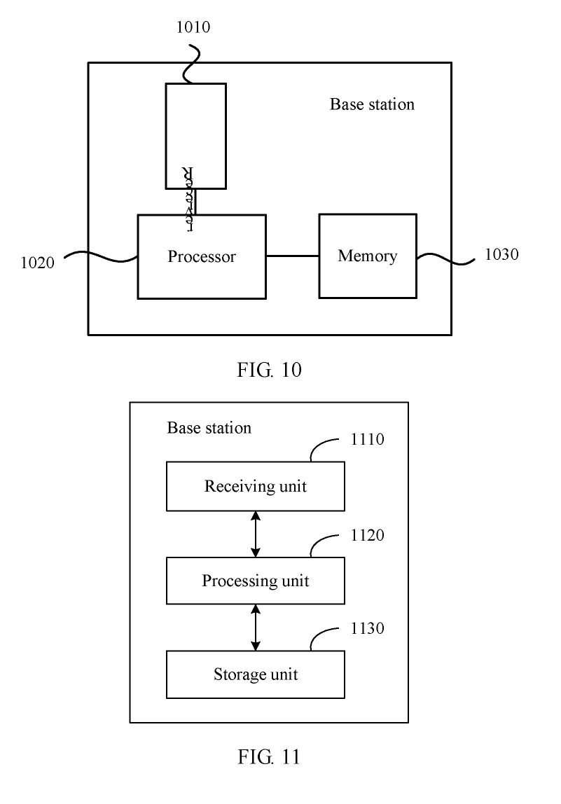

Correspondingly, an embodiment of the present invention provides a base station, to implement the method for feeding back hybrid CSI provided in the foregoing embodiments. As shown in FIG. 10, the base station includes: a receiver 1010, a processor 1020, and a memory 1030.

The receiver 1010 of the base station provided in this embodiment is configured to receive channel state information CSI reported by a terminal device in two stages.

The processor 1020 is configured to determine, based on CSI configuration information, the CSI reported by the terminal device. The CSI configuration information includes at least one of a subframe offset parameter, a codebook parameter, and a CSI reporting indication. The subframe offset parameter is used to indicate a CSI reporting subframe interval corresponding to different CSI-RS resources used when CSI is reported in a first stage and an interval between subframes in which the CSI is reported in the two stages. The codebook parameter is used to indicate a format of the CSI reported in the first stage and a format of CSI reported in a second stage. The CSI reporting indication is used to indicate that the CSI is reported in the first stage, that the CSI is reported in the second stage, or that the CSI is simultaneously reported in the two stages.

In a possible embodiment, the processor 1020 is specifically configured to determine the CSI configuration information based on information that is configured by the terminal device and that is received by the receiver 1010. Alternatively, the processor 1020 is specifically configured to determine the CSI configuration information based on preconfigured information stored in the memory 1030.

In addition, the base station provided in this embodiment of the present invention may further use the following implementation, to implement the method for feeding back hybrid CSI in the foregoing embodiments of the present invention. As shown in FIG. 11, the base station includes: a receiving unit 1110, a processing unit 1120, and a storage unit 1130.

In an optional embodiment, the receiver 1010 in the embodiment in FIG. 11 may be replaced with the receiving unit 1110. The processor 1020 may be replaced with the processing unit 1120. The memory 1030 may be replaced with the storage unit 1130.

For a processing procedure of each unit in FIG. 11, refer to the specific embodiments shown in FIG. 1 to FIG. 7 and FIG. 10. Details are not described herein again.

Persons skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. Persons skilled in the art may use different methods to implement the described functions for each particular application, but it should not be considered that the implementation goes beyond the scope of this application.

Persons of ordinary skill in the art may understand that all or a part of the steps in each of the foregoing method of the embodiments may be implemented by a program instructing a processor. The foregoing program may be stored in a computer readable storage medium. The storage medium may be a non-transitory (English: non-transitory) medium, such as a random-access memory, read-only memory, a flash memory, a hard disk, a solid state drive, a magnetic tape (English: magnetic tape), a floppy disk (English: floppy disk), an optical disc (English: optical disc), or any combination thereof.

The foregoing descriptions are merely examples of specific embodiments of this application, but are not intended to limit the protection scope of this application. Any variation or replacement readily figured out by persons skilled in the art within the technical scope disclosed in this application shall fall within the protection scope of this application. Therefore, the protection scope of this application shall be subject to the protection scope of the claims.

1. A method for feeding back hybrid channel state information (CSI), comprising:
reporting, by a terminal device, CSI to a base station, the CSI being reported in the following stages:
reporting, in a first stage, CSI used when a quantity of beamformed CSI reference signal (CSI-RS) resources is greater than one; and
reporting, in a second stage, CSI used when the quantity of the beamformed CSI-RS resources is equal to one; and
occupying, by the terminal device, one CSI reporting process when reporting the CSI in the two stages.

2. The method of claim 1, wherein the CSI comprises at least one of a CSI-RS resource index (CRI), a rank indicator (RI), a precoding matrix indicator (PMI), or a channel quality indicator (CQI), the CSI being reported in the two stages using a same codebook, the codebook indicating a format of the CSI, and the method further comprising:
reporting, by the terminal device in the first stage, a CRI and an RI or a PMI corresponding to n CSI-RS resources used when the quantity of the beamformed CSI-RS resources is greater than one, the n comprising an integer greater than one; and
reporting, by the terminal device in the second stage, a CRI, a CQI, and an RI or a PMI corresponding to one of the n CSI-RS resources used when the quantity of the beamformed CSI-RS resources is equal to one.

3. The method of claim 1, wherein the CSI comprises at least one of a CSI-RS resource index (CRI), a rank indicator (RI), a precoding matrix indicator (PMI), or a channel quality indicator (CQI), the CSI being reported in the two stages using different codebooks, the different codebooks indicating formats of the CSI, and the method further comprising:
reporting, by the terminal device in the first stage, a CRI, a PMI and an RI corresponding to n CSI-RS resources used when the quantity of the beamformed CSI-RS resources is greater than one, the n comprising an integer greater than one; and
reporting, by the terminal device in the second stage, a CRI, a CQI, a PMI, and an RI corresponding to one of the n CSI-RS resources used when the quantity of the beamformed CSI-RS resources is equal to one.

4. The method of claim 2, wherein the PMI reported in the first stage indicates a group of beams, and the PMI reported in the second stage selecting a beam and a phase from the group of beams.

5. The method of claim 1, wherein a dimension of a codebook reporting the CSI in the first stage is less than a dimension of a codebook reporting the CSI in the second stage.

6. The method of claim 1, further comprising determining, by the terminal device, CSI configuration information comprising at least one of:
a subframe offset parameter indicating a CSI reporting subframe interval corresponding to different CSI-RS resources used when the CSI is reported in the first stage and an interval between subframes in which the CSI is reported in the two stages;
a codebook parameter indicating a format of the CSI reported in the first stage and a format of the CSI reported in the second stage; or
a CSI reporting indication indicating that the CSI is reported in the first stage, that the CSI is reported in the second stage, or that the CSI is simultaneously reported in the two stages.

7. The method of claim 6, wherein determining the CSI configuration information comprises determining, by the terminal device, the CSI configuration information based on information configured or preconfigured by the base station.

8-9. (canceled)

10. A terminal device, comprising:
a transmitter configured to report channel state information (CSI) to a base station, the CSI being reported in the following two stages:
a first stage in which CSI used when a quantity of beamformed CSI reference signal (CSI-RS) resources is greater than one is reported; and
a second stage in which CSI used when the quantity of the beamformed CSI-RS resources is equal to one is reported; and
a processor coupled to the transmitter and configured to occupy one CSI reporting processing when reporting the CSI in the two stages using the transmitter.

11. The terminal device of claim 10, when the CSI comprises at least one of a CSI-RS resource index (CRI), a rank indicator (RI), a precoding matrix indicator (PMI), or a channel quality indicator (CQI), the CSI being reported in the two stages using a same codebook, the codebook indicating a format of the CSI, and the transmitter being further configured to:
report, in the first stage, a CRI, and an RI or a PMI corresponding to n CSI-RS resources used when the quantity of the beamformed CSI-RS resources is greater than one, the n comprising an integer greater than one; and
report, in the second stage, a CRI, a CQI, and an RI or a PMI corresponding to one of the n CSI-RS resources used when the quantity of the beamformed CSI-RS resources is equal to one.

12. The terminal device of claim 10, wherein the CSI comprises at least one of a CRI, a rank indicator (RI), a precoding matrix indicator (PMI), or a channel quality indicator (CQI), the CSI being reported in the two stages using different codebooks, the different codebooks indicating formats of the CSI, and the transmitter being further configured to:
report, in the first stage, a CRI, a PMI and an RI corresponding to n CSI-RS resources used when the quantity of the beamformed CSI-RS resources is greater than one, the n comprising an integer greater than one; and
report, in the second stage, a CRI, a CQI, a PMI, and an RI corresponding to one of the n CSI-RS resources used when the beamformed CSI-RS resources is equal to one.

13. The terminal device of claim 11, wherein the PMI reported in the first stage indicates a group of beams, and the PMI reported in the second stage selecting a beam and a phase from the group of beams.

14. The terminal device of claim 10, wherein a dimension of a codebook reporting the CSI in the first stage is less than a dimension of a codebook reporting the CSI in the second stage.

15. The terminal device of claim 10, wherein the processor is further configured to determine the CSI configuration information comprising at least one of:
a subframe offset parameter indicating a CSI reporting subframe interval corresponding to different CSI-RS resources used when the CSI is reported in the first stage and an interval between subframes in which the CSI is reported in the two stages;
a codebook parameter indicating a format of the CSI reported in the first stage and a format of the CSI reported in the second stage; or
a CSI reporting indication indicating that the CSI is reported in the first stage, that the CSI is reported in the second stage, or that the CSI is simultaneously reported in the two stages.

16. The terminal device of claim 15, further comprising a receiver coupled to the processor, and the processor being further configured to determine the CSI configuration information based on information configured by the base station and received by the receiver.

17. A base station, comprising:
a receiver configured to receive channel state information (CSI) from a terminal device in two stages; and
a processor coupled to the receiver and configured to determine, based on CSI configuration information, the CSI received from the terminal device, the CSI configuration information comprising at least one of:
a subframe offset parameter indicating a CSI reporting subframe interval corresponding to different CSI reference signal (CSI-RS) resources used when CSI is reported in a first stage and an interval between subframes in which the CSI is reported in the two stages;
a codebook parameter indicating a format of the CSI reported in the first stage and a format of CSI reported in a second stage; or
a CSI reporting indication indicating that the CSI is reported in the first stage, that the CSI is reported in the second stage, or that the CSI is simultaneously reported in the two stages.

18. The base station of claim 17, wherein the processor is further configured to determine the CSI configuration information based on information configured by the terminal device and received by the receiver.

19. The terminal device of claim 15, further comprising a memory coupled to the processor, and the processor being further configured to determine the CSI configuration information based on preconfigured information stored in the memory.

20. The base station of claim 17, further comprising a memory coupled to the processor, the processor being further configured to determine the CSI configuration information based on preconfigured information stored in the memory.
